(19) United States
(12) Patent Application Publication
(10) Pub. No.: US 2022/0177816 A1
(43) Pub. Date: Jun. 9, 2022

(54) System and Method for the Production of High Gravity Non-Alcoholic Beer through Minimal Water Addition

(71) Applicant: Alfa Laval Sandymount Technologies Corporation, Wilmington, DE (US)

(72) Inventors: Ronan K. McGovern, Cambridge, MA (US); Erin Partlan, Cambridge, MA (US); Adam M. Weiner, Cambridge, MA (US)

(21) Appl. No.: 17/437,106

(22) PCT Filed: Mar. 12, 2020
(86) PCT No.: PCT/US2020/022387

§ 371 Date: Sep. 8, 2021

Related U.S. Application Data
(60) Provisional application No. 62/817,004, filed on Mar. 12, 2019.
(60) Provisional application No. 62/829,721, filed on Apr. 5, 2019.
(60) Provisional application No. 62/850,215, filed on May 20, 2019.

(51) Int. Cl. C12H 3/04; B01D 61/02; C12C 11/11; C12C 12/04; C12G 3/025

(52) U.S. Cl. CPC C12H 3/04; B01D 61/022; B01D 61/025; B01D 2311/04; C12C 12/04; C12G 3/025; C12C 11/11

(57) ABSTRACT

A high gravity non-alcoholic beverage is disclosed having an ABV between about 0.1% to about 0.8% or between about 3% to about 6%, a real extract by weight between about 15% to about 70%, and an ethyl acetate amount between about 1 to about 500 mg/l. A method for producing the high gravity non-alcoholic beverage from a starting liquid includes providing a set of reverse osmosis pressure vessels, each pressure vessel having a feed inlet, a retentate outlet, and a permeate outlet, the set having a first pressure vessel, providing the starting liquid to the feed inlet of the first pressure vessel, adding water at a blend point when ABV content in a selected one of the permeate streams exceeds ABV content of a retentate stream at the blend point, and obtaining the high gravity non-alcoholic beverage from a selected one of the retentate streams.

### CROSS-REFERENCE TO RELATED APPLICATIONS

The present application claims priority to and the benefit of U.S. Provisional Application Ser. No. 62/850,215 filed May 20, 2019; U.S. Provisional Application Ser. No. 62/829,721 filed Apr. 5, 2019; and U.S. Provisional Application Ser. No. 62/817,004 filed Mar. 12, 2019, each of which is incorporated by reference herein in its entirety.

### TECHNICAL FIELD

The present invention relates to systems and methods for producing high gravity non-alcoholic beverages from a fermented starting liquid having high ethanol content.

### BACKGROUND ART

Various systems and methods are known for concentrating beers and wines using reverse osmosis (RO). Galzy (in U.S. Pat. No. 4,610,887) and Fricker (in U.S. Pat. No. 4,792,402) disclose RO processes—which may be hybridized with distillation—to produce a high alcohol-by-volume (ABV) fermented juice. Bonnome (in U.S. Pat. No. 4,532,140) discloses a two-pass RO system in which retentates are mixed to form a high alcohol beer and wine concentrate. Disclosed also are systems and methods for the production of non-alcoholic beverages, such as by Bonneau (in U.S. Pat. No. 4,499,117) and Gnekow (in U.S. Pat. No. 4,999,209), involving multi-step membrane processes with ultrafiltration (UF) and RO, geared towards retaining all compounds other than ethanol and water.

Known also in the prior art are methods for dealcoholizing beer involving reverse osmosis or nanofiltration, where the beer is first concentrated (typically at pressures of 10 to 30 bar, and temperatures of 10 to 20 degrees Celsius) and both water and ethanol removed as permeate through the membrane, then water is added to dilute the beer while water and ethanol continue to be removed in a batch reverse osmosis process (known as diafiltration). Finally, further water is added to the beer to bring the beer back to a similar concentration of real extract as was present in the original beer.

### SUMMARY OF THE EMBODIMENTS

In accordance with one embodiment of the invention, a high gravity non-alcoholic beverage having an ABV between about 0.1% to about 0.8% or between about 3% to about 6%, a real extract by weight between about 15% to about 70%, and an ethyl acetate amount between about 1 to about 500 mg/l. The high gravity non-alcoholic beverage may be formed by processing a starting liquid having a water content and from which at least 80% of the water content has been removed. In some embodiments, the real extract by weight is between about 25% to about 70%, and in other embodiments, the real extract by weight is between about 35% to about 70%.

In accordance with another embodiment of the present invention, a method for producing a high gravity non-alcoholic beverage from a starting liquid having an ethanol component includes providing a set of reverse osmosis pressure vessels, each pressure vessel having a feed inlet for a feed stream, a retentate outlet for a retentate stream, and a permeate outlet for a permeate stream, the set having a first pressure vessel; providing the starting liquid to the feed inlet of the first pressure vessel; adding water at a blend point when ABV content in a selected one of the permeate streams exceeds ABV content of a retentate stream at the blend point; and obtaining the high gravity non-alcoholic beverage from a selected one of the retentate streams.

In some embodiments, the method for producing a high gravity non-alcoholic beverage from a starting liquid having an ethanol component includes providing a feed tank that contains the starting liquid, the feed tank having an inlet and an outlet, wherein the outlet of the feed tank is fluidly coupled to the feed inlet of the first pressure vessel and the retentate outlet of the first pressure vessel is fluidly coupled to the inlet of the feed tank; and providing the retentate stream to the feed tank to produce a feed liquid, wherein adding the water at the blend point includes adding the water to the feed tank.

In related embodiments, the set may include a second pressure vessel, the retentate outlet of the first pressure vessel fluidly coupled to the feed inlet of the second pressure vessel along a retentate flow path, and wherein the blend point is along the retentate flow path. The total volume of water added may be between about 0 to about 1.0 liters for every liter of starting liquid In some embodiments, the total volume of water added may be between about 0 to about 0.5 liters for every liter of starting liquid The water may be added when the retentate stream has a real extract (RE) concentration by weight between about 8 times to about 25 times an RE concentration by weight of the starting liquid. In some embodiments, the first pressure vessel and/or the second pressure vessel has a length and the water is added when an axial pressure drop across the length reaches between about 30 psi to about 60 psi per forty inches of the length.

The set may further include a third pressure vessel and the retentate outlet of the second pressure vessel may be fluidly coupled to the feed inlet of the third pressure vessel along a second retentate flow path. The method may further include adding water at a second blend point along the second retentate flow path or at the blend point along the first retentate flow path when the ABV content in the permeate stream of the second pressure vessel exceeds the ABV content of the retentate stream of the second pressure vessel. The retentate stream at the blend point may have a real extract (RE) content between about 15% to 70% by weight. In some embodiments, the retentate stream at the blend point may have a real extract (RE) content between about 35% to 70% by weight. The ethanol component in the starting liquid may be ethyl acetate, and between about 5% to about 90% of the ethyl acetate by weight in the starting beverage may be retained in the high gravity non-alcoholic beverage.

### BRIEF DESCRIPTION OF THE DRAWINGS

The foregoing features of embodiments will be more readily understood by reference to the following detailed description, taken with reference to the accompanying drawings, in which:

FIG. 1 is a diagram of an exemplary system employing high pressure reverse osmosis to remove ethanol and water from a starting liquid, resulting in the production of a high gravity non-alcoholic beer according to embodiments of the present invention. Notably, there is no addition of water.

FIG. 2 is a diagram of an exemplary system employing multi-stage high pressure reverse osmosis to remove ethanol and water from a starting liquid, wherein water, e.g., de-aerated water, is added to the liquid between the first and second stages, resulting in the production of a high gravity non-alcoholic beer according to embodiments of the present invention. Notably, the level of total water addition is minimal—no more than 1.0 hectoliters of water per hectoliter of starting liquid, and preferably no more than 0.5 hectoliters of water per hectoliter of starting liquid.

FIG. 3 is a diagram of a batch high pressure reverse osmosis system, where retentate from the reverse osmosis pressure vessels is recirculated back to the feed tank according to embodiments of the present invention. Notably, in certain embodiments of the invention, the total water added to the feed tank is between zero and 0.5 hectoliters per hectoliter of starting liquid. In this case, the feed tank is at a pressure of between 1,250 psi and 3,000 psi and maintained at such pressure using gas or liquid in direct or indirect (for example, via a piston, a diaphragm or a bladder) contact with liquid within the feed tank.

FIGS. 4A through 4D are graphs showing the permeate flow rate, ethanol permeation, real extract concentration of the feed tank and de-brew ABV of the feed tank for a batch process with deaerated water addition at various points in time.

FIGS. 5A through 5D are graphs showing the permeate flow rate, ethanol permeation rate, real extract concentration of the feed tank and de-brew ABV of the feed tank, respectively, for a batch process with deaerated water addition at various points in time, in a process where the total deaerated water added is restricted according to embodiments of the present invention.

FIG. 6 is a graph showing the retentate ABV (data points depicted as triangles) and permeate ABV (data points depicted as circles) versus time in a dealcoholization process with limited blending of deaerated water according to embodiments of the present invention.

FIG. 7 is a diagram of an exemplary system employing three-stage high pressure reverse osmosis having two blend points according to embodiments of the present invention.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

Real Extract: The weight percent of compounds in a beverage other than water and ethanol.

High pressure reverse osmosis: A reverse osmosis process or system in which the retentate stream reaches between about 1,250 psi and 3,000 psi, or more preferably, between about 1,700 psi and 3,000 psi for at least a portion of the process or system.

High gravity non-alcoholic beverage (or High Gravity NAB) is a fermented beverage that has had over 80% of its water content by weight and over 80% of its ethanol content by weight removed via a high pressure reverse osmosis process.

De-brew ABV is the level of alcohol by volume in a diluted sample of a high gravity non-alcoholic beverage, whereby the level of dilution is determined by matching the level of real extract (RE) in the diluted sample to the level of real extract in the starting liquid from which the high gravity non-alcoholic beverage was derived. For example, a beer of 5% ABV and 5% RE may be subjected to a high pressure reverse osmosis process using the methods described in embodiments of this invention, yielding a high gravity non-alcoholic beverage of 5% ABV and 50% RE, and therefore a de-brew ABV of 0.5% ABV (i.e. 50% RE diluted down to 5% RE is a 9:1 dilution with water, bringing the de-brew ABV to 0.5% ABV).

As used herein, “total water added,” and the like, refers to the total water added across all blend points prior to the end of a reverse osmosis process. “Total water added” does not include any water that may be used to dilute the end product of a reverse osmosis process. For example, in a reverse osmosis system having one blend point, the total water added is the total water added at that blend point. In a reverse osmosis system having two blend points, the total water added is the water added at the first blend point, if any, plus the water added at the second blend point, if any.

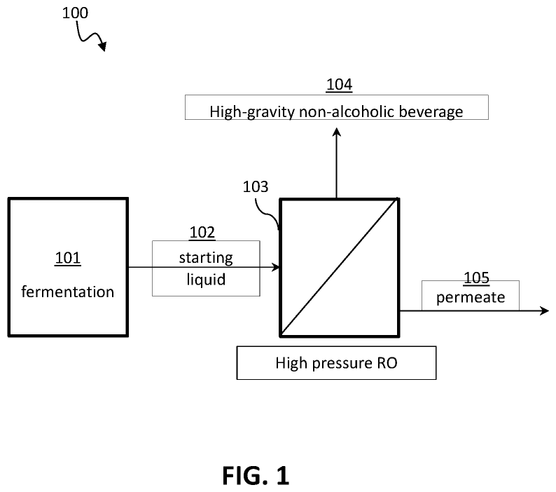

FIG. 1 shows a system 100 employing high pressure reverse osmosis to remove ethanol and water from a starting liquid 102 according to embodiments of the present invention. The starting liquid 102 is derived from a fermentation process 101. The starting liquid 102 is passed through a high pressure reverse osmosis (RO) system 103 to provide a high gravity non-alcoholic beverage as a retentate 104 that is enriched in real extract relative to the starting liquid 102, and a permeate 105, which is diminished in real extract concentration relative to the starting liquid 102. No additional water is added to the starting liquid 102 during the process. In certain embodiments, for a non-alcoholic beer, the level of alcohol by volume of the high gravity non-alcoholic beverage is in the range of about 1.5-5%, while the level of real extract by weight is in the range of about 15% to 45%. In certain embodiments, the system or process is conducted at a temperature of about 8 degrees Celsius to 25 degrees Celsius, or more preferably about 10 to 20 degrees Celsius. In certain embodiments, the system or process is conducted at pressures of about 1,250 to 3,000 psi, or, more preferably about 1,700 to 3,000 psi. The important point, whether the reverse osmosis system or process is operated in batch or continuous mode, is that no water is added to the retentate 104. This approach is not intuitive because conventionally, in dealcoholization, water is added to increase the permeate flow rate. Tests conducted with high pressure reverse osmosis, and zero blending of water, surprisingly, showed improved performance over baseline tests with water addition.

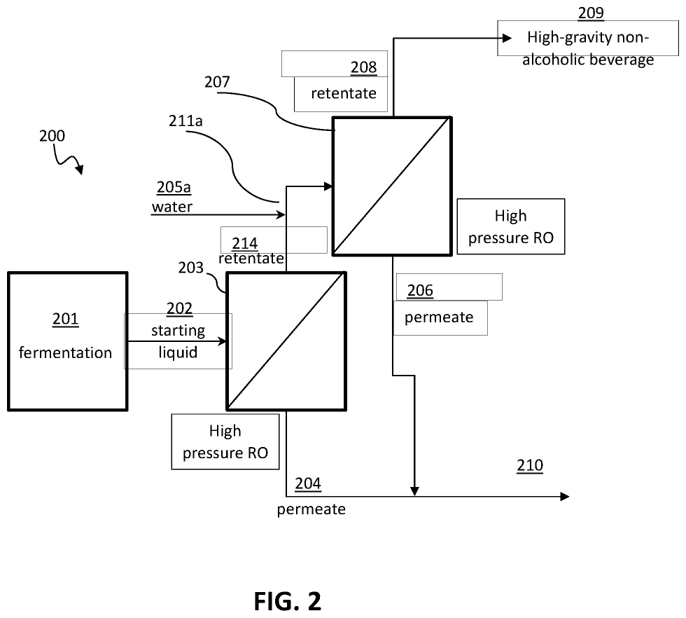

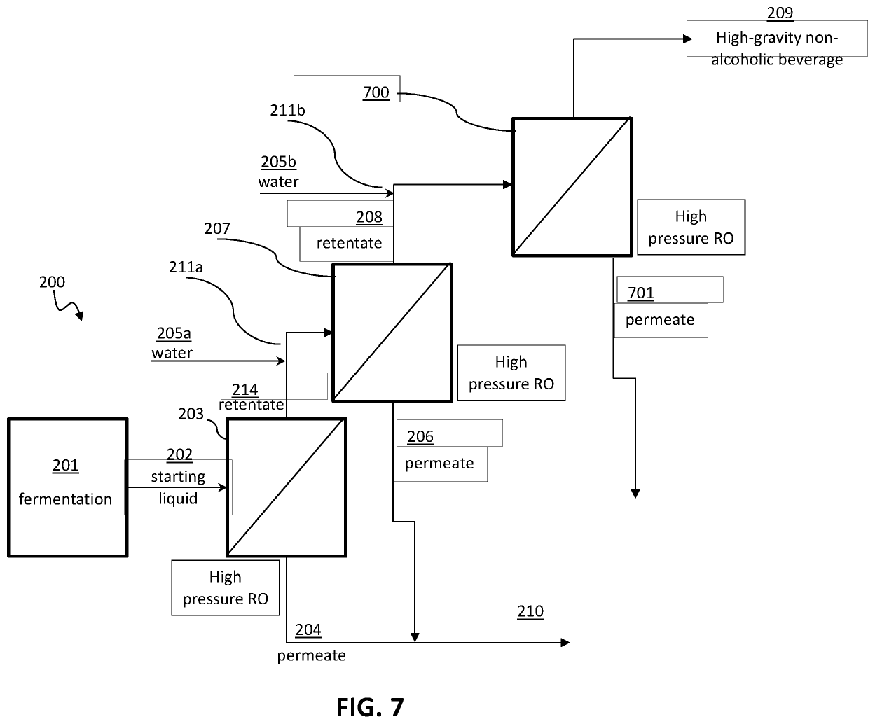

FIG. 2 shows a system 200 employing a two-stage high pressure reverse osmosis process to remove ethanol and water from a starting liquid 202 according to embodiments of the present invention. The starting liquid 202 may be derived from a fermentation process 201 and then the starting liquid 202 is fed to a first reverse osmosis stage 203. Retentate 214 from the first stage 203 is blended with water 205a at blend point 211a and fed to a second high pressure reverse osmosis stage 207, giving rise to retentate 208 and a high gravity non-alcoholic beverage 209. Permeates 204 and 206 consist primarily of water and ethanol that are removed from the starting liquid 202. In certain embodiments, a total volume of water 205a is added in a restricted quantity, for example no more than about 1 liter for every liter of starting liquid 202, and preferably between about 0 and 0.5 liters for every liter of starting liquid 202. Water 205a is preferably de-aerated so as not to add oxygen to the beverage at hand. In certain embodiments, the level of alcohol by volume in retentate 214 is in the range of about 3-6%, while the level of real extract by weight is in the range of about 15% to 70%. In certain embodiments, the level of alcohol by volume in the high gravity non-alcoholic beverage 209 is in the range of about 0.1% to 0.8% alcohol by volume, and the concentration of real extract (RE) by weight is in the range of about 15% to 70%, or more preferably 25% to 70%. In certain embodiments, water 205a is blended only when retentate 214 reaches a concentration of real extract by weight that is between about 10 and 25 times the concentration of real extract in the starting liquid 202. In certain embodiments, the blend point 211 is determined by the axial pressure drop across the RO membranes reaching (in time for a batch process, or in space for a continuous process) a target of about 30 psi to 60 psi per forty inches of membrane length. In certain embodiments where one or more reverse osmosis steps involve batch processes, the cross-flow through the RO membranes is controlled to keep the axial pressure drop per 40 inches of length to be in a range of about 30 psi to 60 psi. Although two stages 203, 207 are shown in FIG. 2, any number of stages may be used. In addition, one or more blend points 211 may be used along each of the retentate flow paths, either before or after the pressure vessel that has the axial pressure drop. For example, there may be multiple blend points 211, e.g., one to six blend points, along the retentate flow path between the retentate outlet of the first reverse osmosis stage 203 and the feed inlet of the second reverse osmosis stage 207 and three or more high pressure reverse osmosis stages may be used with one or more blend points 211 along each of the retentate flow paths. FIG. 7, for example, shows a three-stage high pressure reverse osmosis process having two blend points 211a and 211b at which water 205a and 205b may be added. In certain embodiments, permeate 204 or 206 may be subjected to a further high pressure reverse osmosis process using methods described in embodiments of this invention, in order to further recover aromas. In such cases, a portion of the final retentate from such an aroma recovery process may be blended with high-gravity non-alcoholic beverage 209 to improve its flavor.

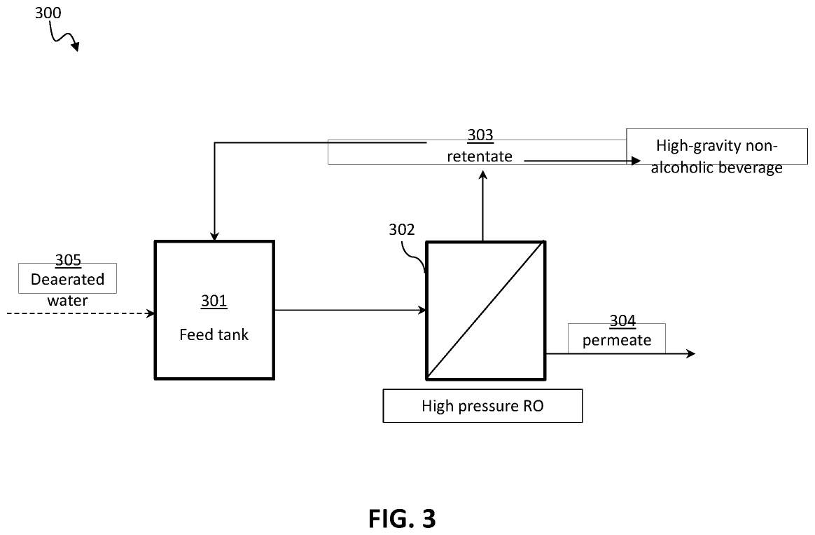

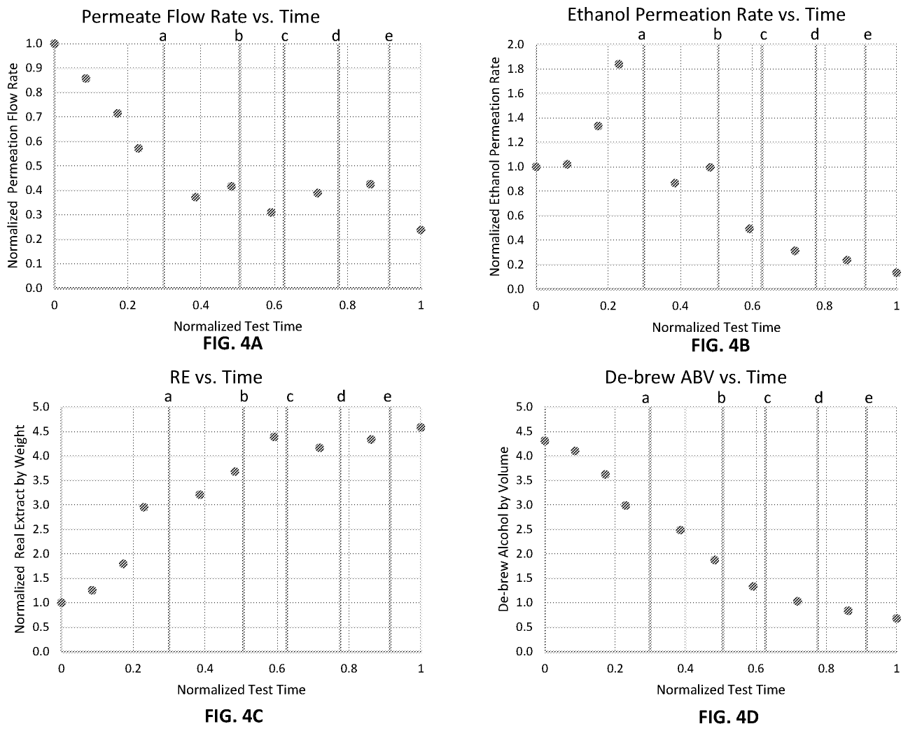

FIG. 3 is a diagram of a high pressure reverse osmosis system 300, conducted in batch mode, with retentate 303 recirculated to feed tank 301, and feed tank 301 feeding high pressure RO system 302. When the ethanol content reaches the desired ABV in the retentate 303, then the retentate is removed as the high-gravity non-alcoholic beverage either from the feed tank 301 or directly from the retentate stream (as shown in FIG. 3). Permeate 304 is removed from the high pressure RO system 302. A first test was conducted using this type of setup, and with substantial amounts of water blended at various points during the process. The results are shown in FIGS. 4A-4D.

FIGS. 4A-4D are graphs illustrating the results of a high pressure reverse osmosis process using the system of FIG. 3 with substantial (e.g., over 0.5 hl of water per hl of starting liquid) blending of water. In FIGS. 4A through 4D, time is normalized by the total test time. In FIG. 4A, permeate flow is normalized by the initial flow, and in FIG. 4B, ethanol permeation rate is normalized by the initial ethanol permeation rate. In FIG. 4C, RE is normalized by the initial RE in the starting liquid. In FIG. 4D, de-brew ABV is as described in the definitions. The grey vertical lines a-e signify points in time where additions of deaerated water equaling roughly 10%-15% of the starting volume of liquid were made. FIG. 4A shows that, as the test proceeds, permeate flow falls. Due to falling permeate flow water was blended starting at a normalized test time of 0.3. This is conventional wisdom, whereby water is added in order to improve permeate flow. However, on reflection, a better measure of process performance seemed to be the flow of ethanol permeating the membrane, which is the product of permeate concentration and permeate flow rate. Interestingly, when ethanol permeation rate was plotted in FIG. 4B, it turns out that while blending water can improve permeate flow (see 4A—or at least slow its decline), the blending of water generally makes the ethanol permeation rate worse, not better. Ultimately, this is a dealcoholization process, so reducing ethanol permeation rate is detrimental to the process. Thus, embodiments of the present invention reduce as much as possible the amount of water blended during the process, in order to keep the ethanol permeation rate high. For reference, FIG. 4C is included, which shows that real extract concentration increases throughout the test, although its increase is kept at bay by water additions. FIG. 4D shows the progression of the dealcoholization, with the debrew ABV almost reaching 0.5% by the end of the test. This test was done at high pressures, between 1,500 psi and 2,500 psi, and these high pressures appear to allow the system to boost the ethanol permeation rate relative to the conventional pressures used in diafiltration processes, which are about 600 psi. One further problem with the first test is that blending was necessary because, at certain points during the test, the level of liquid in the feed tank became too low and gas started to be entrained by the pump in the reverse osmosis system 302. In other words, a hold-up volume was reached with the system and water addition was necessary to continue with the process. This can also be an issue in industrial diafiltration processes.

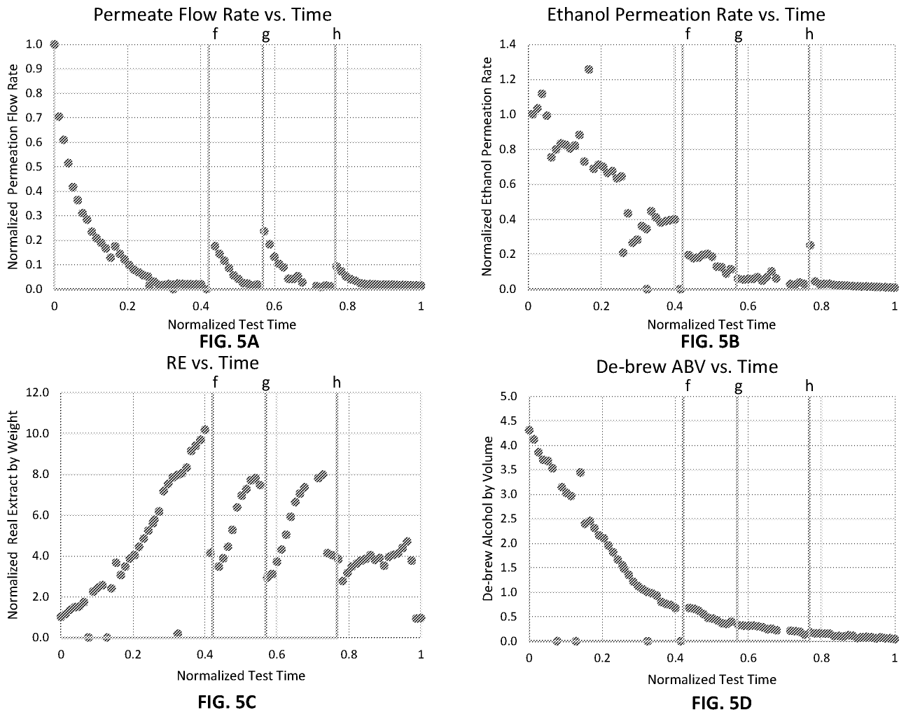

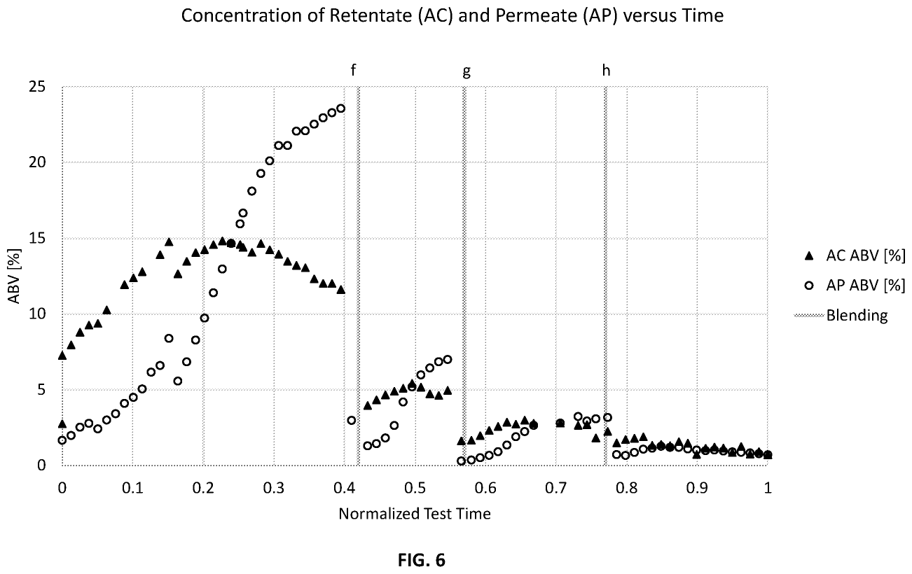

FIGS. 5A-5D are graphs showing the results from a second test using the system of FIG. 3 where water addition was greatly restricted according to embodiments of the present invention. The grey vertical lines (f, g, and h) in the graphs show where additions of water were made and the quantity of water blended at each vertical line is approximately 5%-10% of the starting volume. To overcome the hold-up problem that was encountered with the first test, the starting volume of liquid was increased in the second test, so that the point at which the hold-up volume was reached was delayed. As shown in FIG. 5D, the first blend point, shown with the vertical line f, was delayed very significantly compared to the first blend point, shown with the vertical line a, in the first test. The de-brew ABV is almost 0.5% ABV by the time any deaerated water is added. In addition, a very high concentration of RE was reached, as seen in FIG. 5C. RE reached over ten times its initial value before water was added. The limit at this point was the axial pressure drop across the membranes, which reached between 30 and 60 psi per forty inches of flow path length in the membranes. At this point, axial compression of the membranes and damage can occur. The ethanol in the system also becomes quite concentrated, before being removed, and the concentration of alcohol by volume in the permeate actually exceeds that of the concentration of alcohol by volume in the retentate at the same time, as seen in FIG. 6. While this may appear to imply a negative value of ethanol rejection by the membrane process, it is a result of the high concentrations of RE observed at the same point in the process. Therefore, RE concentration is beneficial to ethanol removal. In the whole process, only a total of about 0.2-0.3 hl of water was added per hl of starting volume. The benefit of minimal water addition is that the level of ethanol remains high in the retentate throughout the process, which promotes diffusion/passage of ethanol through the membrane. By contrast, in a conventional diafiltration process, the level of ethanol in the retentate gets very low (e.g., well below 1% ABV) as water is added and the rate of ethanol permeation becomes minimal. Even though ethanol permeation rate fell significantly in FIG. 5B, the ethanol permeation rate was maintained significantly higher than would have been the case with voluminous blending.

Such high gravity non-alcoholic beverages, as made with the systems shown in FIGS. 1 through 3, may favorably be stored, including in a bag in box or a keg, with minimal microbial growth, owing to the presence of ethanol. When diluted, by factors of about 20:1 down to 3:1, with water, a non-alcoholic beverage of about 0.3% to 1.2% may be formed from the high gravity non-alcoholic beverage made according to the first test (FIG. 4), or of about 0.01% to 0.05% may be formed from the high gravity non-alcoholic beverage made according to the second test (FIG. 5). Thus, certain embodiments of the invention include a high gravity non-alcoholic beverage produced via high pressure reverse osmosis with zero or minimal water addition, exhibiting superior microbial stability, over a non-alcoholic beverage that is stored in final form, whether at about 0.5% ABV or about 0.05% ABV.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A method for producing a high gravity non-alcoholic beverage from a starting liquid having an ethanol component, the method comprising:

providing a set of reverse osmosis pressure vessels, each pressure vessel having a feed inlet for a feed stream, a retentate outlet for a retentate stream, and a permeate outlet for a permeate stream, the set having a first pressure vessel and a second pressure vessel, the retentate outlet of the first pressure vessel fluidly coupled to the feed inlet of the second pressure vessel along a retentate flow path;

providing the starting liquid to the feed inlet of the first pressure vessel;

adding water at a first blend point along the retentate flow path when a desired real extract (RE) content is reached in the retentate stream of the first pressure vessel, wherein the water has a volume between about 0 to about 0.5 liters per liter of the starting liquid; and obtaining the high gravity non-alcoholic beverage from the retentate stream of the second pressure vessel.

P2. The method of claim P1, wherein the water is deaerated water.
P3. The method of claims P1 or P2, wherein the water is added in a range between about 0.05 to about 0.35 liters for every liter of starting liquid.
P4. The method of any one of claims P1 to P3, wherein the water is added when the retentate stream has an RE concentration by weight between about 10 times to about 25 times an RE concentration by weight of the starting liquid.
P5. The method of any one of claims P1 to P4, wherein the retentate flow path has a length and the blend point is positioned along the length such that a pressure drop reaches between about 10 psi to about 50 psi per forty inches of the length.
P6. The method of any one of claims P1 to P5, wherein the set further includes a third pressure vessel, wherein the retentate outlet of the second pressure vessel is fluidly coupled to the feed inlet of the third pressure vessel along a second retentate flow path, the method further comprising adding water at a second blend point along the second retentate flow path when a desired RE content is reached in the retentate stream of the second pressure vessel, wherein the water added at the first blend point and the water added at the second blend point has a volume between about 0 to about 0.5 liters per liter of the starting liquid.
P7. The method of any one of claims P1 to P6, wherein the starting liquid is derived from a fermentation process.
P8. The method of any one of claims P1 to P7, wherein the retentate stream of the second pressure vessel has an ethanol content between about 1.5% to about 5% ABV.
P9. The method of any one of claims P1 to P8, wherein the retentate stream of the second pressure vessel has a real extract (RE) content between about 15% to 45% by weight.
P10. The method of any one of claims P1 to P9, wherein the high gravity non-alcoholic beverage has an ethanol content between about 0.2% to about 1% ABV.
P11. The method of any one of claims P1 to P10, wherein the high gravity non-alcoholic beverage has an RE content between about 15% to 45% by weight.
P12. The method of any one of claims P1 to P11, wherein the set further includes a third pressure vessel, wherein the permeate outlet of the first pressure vessel and/or the permeate outlet of the second pressure vessel is fluidly coupled to the feed inlet of the third pressure vessel, the method further comprising adding the retentate stream from the third pressure vessel to the high gravity non-alcoholic beverage.
P13. The method of any one of claims P1 to P12, wherein the first blend point may include two or more blend points along the retentate flow path.
P14. The method of any one of claims P1 to P13, wherein the ethanol component in the starting liquid is ethyl acetate, and between about 5% to about 90% of the ethyl acetate by weight in the starting beverage is retained in the high gravity non-alcoholic beverage.
P15. A method for producing a high gravity non-alcoholic beverage from a starting liquid having an ethanol component, the method comprising:

providing a feed tank that contains the starting liquid, the feed tank having an inlet and an outlet;

providing a set of reverse osmosis pressure vessels, each pressure vessel having a feed inlet for a feed stream, a retentate outlet for a retentate stream, and a permeate outlet for a permeate stream, the set having a first pressure vessel, wherein the outlet of the feed tank is fluidly coupled to the feed inlet of the first pressure vessel and the retentate outlet of the first pressure vessel is fluidly coupled to the inlet of the feed tank;

providing the retentate stream to the feed tank to produce a feed liquid;

adding water to the feed tank when a desired RE content is reached in the feed liquid, wherein a total volume of water added is between about 0 to about 0.5 liters per liter of the starting liquid; and

obtaining the high gravity non-alcoholic beverage from the retentate stream of the first pressure vessel.

P16. The method of claim P15, wherein the water is deaerated water.
P17. The method of claims P15 or P16, wherein the total volume of water added is between about 0.05 to about 0.35 liters for every liter of starting liquid.
P18. The method of any one of claims P15 to P17, wherein the water is added when the retentate stream has an RE concentration by weight between about 10 times to about 25 times a RE concentration by weight of the starting liquid.
P19. The method of any one of claims P15 to P18, wherein the starting liquid is derived from a fermentation process.
P20. The method of any one of claims P15 to P19, wherein the high gravity non-alcoholic beverage has an ethanol content between about 0.2% to about 1% ABV.
P21. The method of any one of claims P15 to P20, wherein the high gravity non-alcoholic beverage has an RE content between about 15% to 45% by weight.
P22. The method of any one of claims P15 to P21, wherein the set further includes a second pressure vessel, wherein the permeate outlet of the first pressure vessel is fluidly coupled to the feed inlet of the second pressure vessel, the method further comprising adding the retentate stream from the second pressure vessel to the high gravity non-alcoholic beverage.
P23. The method of any one of claims P15 to P22, wherein the ethanol component in the starting liquid is ethyl acetate, and between about 5% to about 90% of the ethyl acetate by weight in the starting beverage is retained in the high gravity non-alcoholic beverage.
P24. A high gravity non-alcoholic beverage produced by the process of any one of claims P1 to P23.
P25. A high gravity non-alcoholic beverage having an ABV between about 2% to about 5%, a real extract by weight between about 5% to about 50%, and an ethyl acetate amount between about 1 to about 500 mg/l.
P26. A high gravity non-alcoholic beverage having an ABV between about 0.2% to about 0.5%, a real extract by weight between about 5% to about 50%, and an ethyl acetate amount between about 1 to about 500 mg/l.
P27. A high gravity non-alcoholic beverage having an ABV between about 0.1% to about 0.8% or between about 3% to about 6%, a real extract by weight between about 15% to about 70%, and an ethyl acetate amount between about 1 to about 500 mg/l.
P28. A high gravity beverage according to claim P27, formed by processing a starting liquid having a water content and from which at least 80% of the water content has been removed.
P29. A high gravity beverage according to claim P27, wherein the real extract by weight is between about 25% to about 70% or between about 35% to about 70%.
P30. A method for producing a high gravity non-alcoholic beverage from a starting liquid having an ethanol component, the method comprising:

providing a set of reverse osmosis pressure vessels, each pressure vessel having a feed inlet for a feed stream, a retentate outlet for a retentate stream, and a permeate outlet for a permeate stream, the set having a first pressure vessel;

providing the starting liquid to the feed inlet of the first pressure vessel;

adding water at a blend point when ABV content in a selected one of the permeate streams exceeds ABV content of a retentate stream at the blend point; and

obtaining the high gravity non-alcoholic beverage from a selected one of the retentate streams.

P31. The method of claim P30, further comprising:

providing a feed tank that contains the starting liquid, the feed tank having an inlet and an outlet, wherein the outlet of the feed tank is fluidly coupled to the feed inlet of the first pressure vessel and the retentate outlet of the first pressure vessel is fluidly coupled to the inlet of the feed tank; and

providing the retentate stream to the feed tank to produce a feed liquid, wherein adding the water at the blend point includes adding the water to the feed tank.

P32. The method of claim P30, wherein the set further comprises a second pressure vessel, the retentate outlet of the first pressure vessel fluidly coupled to the feed inlet of the second pressure vessel along a retentate flow path, and wherein the blend point is along the retentate flow path.
P33. The method of any one of claims P30 to P32, wherein the water is deaerated water.
P34. The method of any one of claims P30 to P33, wherein a total water added is in a range between about 0 to about 1.0 liters for every liter of the starting liquid.
P35. The method of any one of claims P30 to P34, wherein a total water added is in a range between about 0 to about 0.5 liters for every liter of the starting liquid.
P36. The method of any one of claims P30 to P35, wherein the water is added when a selected one of the retentate streams has a real extract (RE) concentration by weight between about 8 times to about 25 times an RE concentration by weight of the starting liquid.
P37. The method of any one of claims P32 to P36, wherein the first pressure vessel and/or the second pressure vessel has a length and the water is added when an axial pressure drop across the length reaches between about 30 psi to about 60 psi per forty inches of the length.
P38. The method of any one of claims P32 to P37, wherein the set further includes a third pressure vessel, wherein the retentate outlet of the second pressure vessel is fluidly coupled to the feed inlet of the third pressure vessel along a second retentate flow path, the method further comprising adding water at a second blend point along the second retentate flow path or at the blend point along the first retentate flow path when the ABV content in the permeate stream of the second pressure vessel exceeds the ABV content of the retentate stream of the second pressure vessel.
P39. The method of any one of claims P30 to P38, wherein the starting liquid is derived from a fermentation process.
P40. The method of any one of claims P32 to P39, wherein the retentate stream at the blend point has a real extract (RE) content between about 15% to 70% by weight.
P41. The method of any one of claims P32 to P40, wherein the retentate stream at the blend point has a real extract (RE) content between about 35% to 70% by weight.
P42. The method of any one of claims P30 to P41, wherein the high gravity non-alcoholic beverage has an ethanol content between about 0.1% to about 0.8% ABV.
P43. The method of any one of claims to P30 to P42, wherein the high gravity non-alcoholic beverage has an RE content between about 15% to 70% by weight.
P44. The method of any one of claims to P30 to P42, wherein the high gravity non-alcoholic beverage has an RE content between about 35% to 70% by weight.
P45. The method of any one of claims P32 to P44, wherein the blend point may include two or more blend points along one or more of the retentate streams.
P46. The method of any one of claims P30 to P45, wherein the ethanol component in the starting liquid is ethyl acetate, and between about 5% to about 90% of the ethyl acetate by weight in the starting beverage is retained in the high gravity non-alcoholic beverage.

The embodiments of the invention described above are intended to be merely exemplary; numerous variations and modifications will be apparent to those skilled in the art. All such variations and modifications are intended to be within the scope of the present invention as defined in by the appended claims.

1. A high gravity non-alcoholic beverage having an ABV between about 0.1% to about 0.8% or between about 3% to about 6%, a real extract by weight between about 15% to about 70%, and an ethyl acetate amount between about 1 to about 500 mg/l.

2. A high gravity beverage according to claim 1, formed by processing a starting liquid having a water content and from which at least 80% of the water content has been removed.

3. A high gravity beverage according to claim 1, wherein the real extract by weight is between about 25% to about 70% or between about 35% to about 70%.

4. A method for producing a high gravity non-alcoholic beverage from a starting liquid having an ethanol component, the method comprising:
providing a set of reverse osmosis pressure vessels, each pressure vessel having a feed inlet for a feed stream, a retentate outlet for a retentate stream, and a permeate outlet for a permeate stream, the set having a first pressure vessel;
providing the starting liquid to the feed inlet of the first pressure vessel;
adding water at a blend point when ABV content in a selected one of the permeate streams exceeds ABV content of a retentate stream at the blend point; and
obtaining the high gravity non-alcoholic beverage from a selected one of the retentate streams.

5. The method of claim 4, further comprising:
providing a feed tank that contains the starting liquid, the feed tank having an inlet and an outlet, wherein the outlet of the feed tank is fluidly coupled to the feed inlet of the first pressure vessel and the retentate outlet of the first pressure vessel is fluidly coupled to the inlet of the feed tank; and
providing the retentate stream to the feed tank to produce a feed liquid, wherein adding the water at the blend point includes adding the water to the feed tank.

6. The method of claim 4, wherein the set further comprises a second pressure vessel, the retentate outlet of the first pressure vessel fluidly coupled to the feed inlet of the second pressure vessel along a retentate flow path, and wherein the blend point is along the retentate flow path.

7. The method of claim 4, wherein a total water added is in a range between about 0 to about 1.0 liters for every liter of the starting liquid.

8. The method of claim 4, wherein a total water added is in a range between about 0 to about 0.5 liters for every liter of the starting liquid.

9. The method of claim 4, wherein the water is added when a selected one of the retentate streams has a real extract (RE) concentration by weight between about 8 times to about 25 times an RE concentration by weight of the starting liquid.

10. The method of claim 6, wherein the first pressure vessel and/or the second pressure vessel has a length and the water is added when an axial pressure drop across the length reaches between about 30 psi to about 60 psi per forty inches of the length.

11. The method of claim 6, wherein the set further includes a third pressure vessel, wherein the retentate outlet of the second pressure vessel is fluidly coupled to the feed inlet of the third pressure vessel along a second retentate flow path, the method further comprising adding water at a second blend point along the second retentate flow path or at the blend point along the first retentate flow path when the ABV content in the permeate stream of the second pressure vessel exceeds the ABV content of the retentate stream of the second pressure vessel.

12. The method of claim 6, wherein the retentate stream at the blend point has a real extract (RE) content between about 15% to 70% by weight.

13. The method of claim 6, wherein the retentate stream at the blend point has a real extract (RE) content between about 35% to 70% by weight.

14. The method of claim 4, wherein the high gravity non-alcoholic beverage has an ethanol content between about 0.1% to about 0.8% ABV.

15. The method of claim 4, wherein the ethanol component in the starting liquid is ethyl acetate, and between about 5% to about 90% of the ethyl acetate by weight in the starting beverage is retained in the high gravity non-alcoholic beverage.
